(19) United States
(12) Patent Application Publication
(10) Pub. No.: US 2014/0353505 A1
(43) Pub. Date: Dec. 4, 2014

(54) DEFECT INSPECTING APPARATUS AND DEFECT INSPECTING METHOD

(71) Applicants: Tokyo Electron Limited, Tokyo (JP); Seiko Epson Corporation, Tokyo (JP)

(72) Inventors: Tetsuya Sada, Kumamoto (JP); Jun Nishiyama, Kumamoto (JP); Yu Konta, Yamanashi (JP); Kiyomi Oshima, Yamanashi (JP); Hiromi Saito, Nagano (JP); Shuichi Takei, Nagano (JP)

(73) Assignees: Tokyo Electron Limited, Tokyo (JP); Seiko Epson Corporation, Tokyo (JP)

(21) Appl. No.: 14/287,460

(22) Filed: May 27, 2014

(30) Foreign Application Priority Data
May 30, 2013 (JP) 2013-113990

(51) Int. Cl. G01N 21/88; G01N 21/95

(52) U.S. Cl. CPC G01N 21/8806; G01N 21/9501
USPC 250/341.4; 250/338.1

(57) ABSTRACT

Disclosed is an apparatus for appropriately inspecting a defect on at least one of organic layers stacked on a substrate in an organic light emitting diode. The apparatus includes: an illumination unit configured to irradiate a near infrared light of a wavelength ranging from 0.7 μm to 2.5 μm toward the at least one of the organic layers on a glass substrate; an imaging unit configured to image the at least one of the organic layers irradiated with the near infrared light illuminated from the illumination unit; and a processing container configured to accommodate the illumination unit and the imaging unit therein and perform inspection of the at least one of the organic layers. An inside of the processing container is maintained in an atmosphere at an oxygen concentration lower than an oxygen concentration of air and at a dew point temperature lower than a dew point temperature of air.

### CROSS-REFERENCE TO RELATED APPLICATIONS

This application is based on and claims priority from Japanese Patent Application No. 2013-113990, filed on May 30, 2013, with the Japan Patent Office, the disclosure of which is incorporated herein in its entirety by reference.

### TECHNICAL FIELD

The present disclosure relates to a defect inspecting apparatus for inspecting a defect on each of organic layers stacked on a substrate in an organic light emitting diode, and a defect inspecting method, a program and a computer storage medium which use the defect inspecting apparatus.

### BACKGROUND

An organic light emitting diode (OLED) is a light emitting diode using light emission of organic electroluminescence (EL). An organic EL display using the OLED is advantageous in that it is thin and lightweight, requires a low power consumption, and is excellent in a response speed, a viewing angle, and a contrast ratio. Thus, the organic EL display has recently been spotlighted as a next-generation flat panel display (FPD).

The OLED has a structure in which, a hole injection layer, a hole transport layer, a light emitting layer, an electron transport layer, and an electron injection layer are stacked in this order from an anode side between the anode and a cathode on, for example, a substrate. Since each of the stacked organic layers is formed in a thin film of several tens nm, influence of defects of the organic layers remarkably appears. That is, for example, in forming the organic layers, when there are defects such as, for example, coating unevenness occurring at the time of coating organic materials on a substrate, or particles adhered on the organic layers, for example, the electrical property of the OLED may not be achieved or a short circuit may be caused, resulting in a lighting failure. Accordingly, it is required to inspect a defect in each of the organic layers.

As such an inspection apparatus of a substrate, for example, Japanese Patent Laid-Open Publication No. 2011-99875 discloses an inspection apparatus for inspecting film unevenness of a resist film on a glass substrate. In the inspection apparatus, an illumination light is irradiated from an illumination unit to the glass substrate, and the glass substrate is imaged by a line sensor camera. Based on the imaged image, defects are inspected.

As for a light source of the illumination unit, for example, a halogen lamp is generally used as disclosed in, for example, Japanese Patent Laid-Open Publication No. 2008-89306. A visible light is irradiated from the illumination unit to the glass substrate.

### SUMMARY

The present disclosure provides an apparatus for inspecting a defect on at least one of organic layers stacked on a substrate in an organic light emitting diode. The apparatus includes: an illumination unit configured to irradiate a near infrared light toward the at least one of the organic layers on the substrate; and an imaging unit configured to image the at least one of the organic layers irradiated with the near infrared light illuminated from the illumination unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flow chart illustrating a main process of a method of manufacturing an organic light emitting diode (OLED).

FIG. 2 is a side view schematically illustrating the configuration of the OLED.

FIG. 3 is a plan view schematically illustrating the configuration of a partition wall of the OLED.

FIG. 4 is a plan view schematically illustrating the configuration of a substrate processing system provided with a defect inspecting apparatus according to an exemplary embodiment.

FIG. 5 is a cross-sectional view schematically illustrating the configuration of the defect inspecting apparatus.

FIG. 6 is a vertical cross-sectional view schematically illustrating the configuration of the defect inspecting apparatus.

FIG. 7 is a plan view schematically illustrating the configuration of a substrate processing system according to another exemplary embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made without departing from the spirit or scope of the subject matter presented here.

However, through intensive studies, the inventors have found that when a visible light is irradiated to a substrate as in the conventional technology, an adverse influence, such as, for example, coating unevenness, or degradation of an electrical property is caused in an organic material coated on the substrate, and thus the organic material itself is deteriorated by the visible light. Accordingly, in a conventional inspecting method, it is impossible to properly inspect each of organic layers of an organic light emitting diode (OLED).

The present disclosure has been made in consideration of these problems, and an object of the present disclosure is to appropriately inspect a defect on each of organic layers stacked on a substrate in an OLED.

In order to achieve the object, according to an aspect of the present disclosure, an apparatus for inspecting a defect on at least one of organic layers stacked on a substrate in an OLED. The apparatus includes: an illumination unit configured to irradiate a near infrared light toward the at least one of the organic layers on the substrate; and an imaging unit configured to image the at least one of the organic layers irradiated with the near infrared light illuminated from the illumination unit.

According to the present disclosure, the near infrared light is irradiated from the illumination unit to the organic layer on the substrate, and the organic layer irradiated with the near infrared light is imaged by the imaging unit so as to inspect the defect on the organic layer. Here, through intensive studies, the inventors have found that, the organic layer is not deteriorated by the near infrared light because the near infrared light has a lower energy than a visible light. As described above, it was also found that even when the near infrared light of a long wavelength is used, a defect on the organic layer is sufficiently distinguishable by an image imaged by the imaging unit. Accordingly, it is possible to properly inspect a defect on each of organic layers on the substrate.

Further, each time each organic layer is formed on the substrate, defect inspection of the present disclosure may be performed. Thus, for example, when the organic layer is found to be defective, it is not required to further form following organic layers, thereby omitting unnecessary processings. Accordingly, it is possible to improve the manufacturing efficiency of the OLED.

A wavelength of the near infrared light may range from 0.7 μm to 2.5 μm.

The apparatus may further include a processing container configured to accommodate the illumination unit and the imaging unit therein, and perform inspection of the at least one of the organic layers. An inside of the processing container may be maintained in an atmosphere at an oxygen concentration lower than an oxygen concentration of air and at a dew point temperature lower than a dew point temperature of air.

The at least one of the organic layers may be a hole injection layer, a hole transport layer or a light emitting layer.

When the at least one of the organic layers is formed, a coating processing of an organic material on the substrate, a drying processing of the organic material, and a firing processing of the organic material may be sequentially performed in this order. Inspection of the at least one of the organic layers may be performed after the drying processing or the firing processing.

According to another aspect of the present disclosure, a method of inspecting a defect on at least one of organic layers stacked on a substrate in an OLED. The method may include: irradiating a near infrared light toward the at least one of the organic layers on the substrate from an illumination unit; and imaging the at least one of the organic layers irradiated with the near infrared light illuminated from the illumination unit by an imaging unit.

A wavelength of the near infrared light may range from 0.7 μm to 2.5 μm.

Inspection of the at least one of the organic layers may be performed under an atmosphere at an oxygen concentration lower than an oxygen concentration of air, and at a dew point temperature lower than a dew point temperature of air.

The at least one of the organic layers may be a hole injection layer, a hole transport layer or a light emitting layer.

When the at least one of the organic layers is formed, a coating processing of an organic material on the substrate, a drying processing of the organic material, and a firing processing of the organic material may be sequentially performed in this order. Inspection of the at least one of the organic layers may be performed after the drying processing or the firing processing.

According to a further aspect of the present disclosure, a program is operated in a computer of a defect inspecting apparatus to execute the defect inspecting method by the defect inspecting apparatus.

According to a still further aspect of the present disclosure, a computer-readable storage medium stores the program.

According to the present disclosure, it is possible to properly inspect a defect on each of organic layers stacked on the substrate in the OLED.

Hereinafter, exemplary embodiments of the present disclosure will be described. In an exemplary embodiment, descriptions will be made on a defect inspecting apparatus of inspecting a defect on each of organic layers to be stacked on a glass substrate in manufacturing an OLED, and a defect inspecting method using the defect inspecting apparatus.

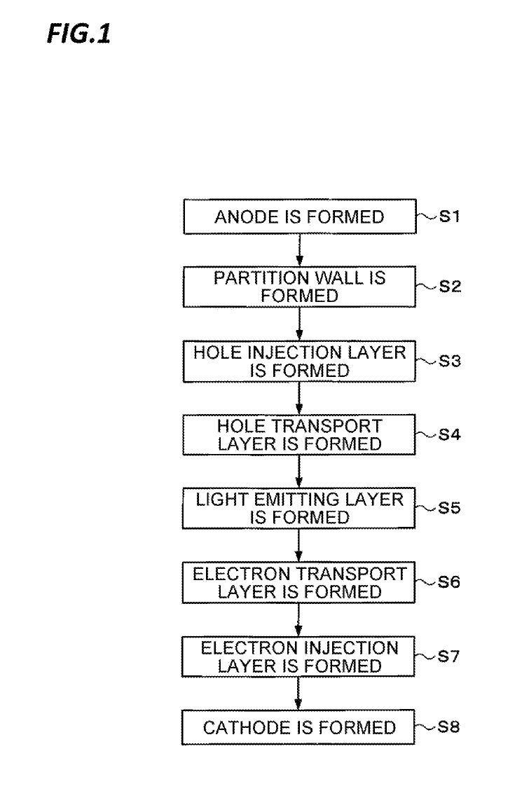

First, a method of manufacturing an OLED will be described. FIG. 1 illustrates a main processing flow of a method of manufacturing an OLED.

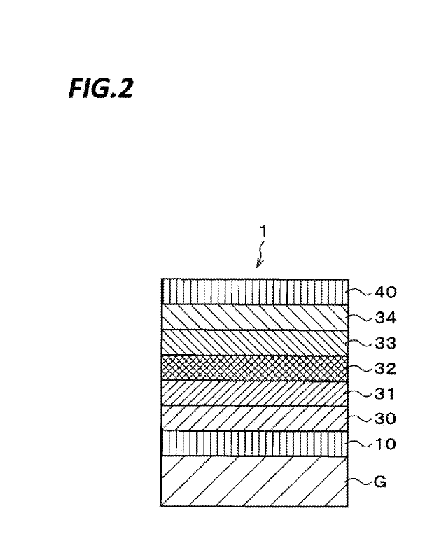

First, as illustrated in FIG. 2, in manufacturing an OLED 1, an anode 10 is formed on a glass substrate G as a substrate (step S1 in FIG. 1). The anode 10 is formed by, for example, a deposition method. As for the anode 10, a transparent electrode made of, for example, indium tin oxide (ITO) is used.

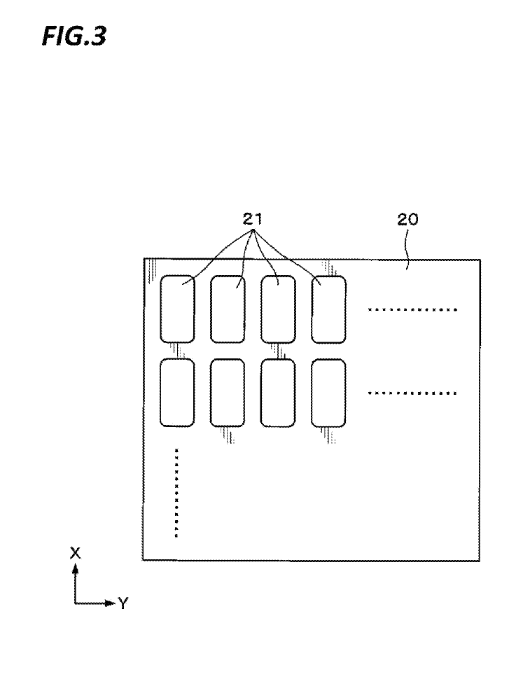

Then, a partition wall 20 is formed on the anode 10, as illustrated in FIG. 3 (step S2 in FIG. 1). The partition wall 20 is patterned in a predetermined pattern through, for example, a photolithography processing and an etching processing. A plurality of slit-shaped openings 21 is formed in the partition wall 20 to be arranged in the row direction (the X direction) and the column direction (the Y direction). Within the openings 21, a plurality of organic layers 30 to 34 and a cathode 40 are stacked to form pixels as described below. The partition wall 20 is made of, for example, a photosensitive polyimide resin.

Within the openings 21 of the partition wall 20, as illustrated in FIG. 2, the plurality of organic layers 30 to 34 are formed on the anode 10. Specifically, a hole injection layer 30 as an organic layer is formed on the anode 10 (step S3 in FIG. 1), a hole transport layer 31 as an organic layer is formed on the hole injection layer 30 (step S4 in FIG. 1), a light emitting layer 32 as an organic layer is formed on the hole transport layer 31 (step S5 in FIG. 1), an electron transport layer 33 as an organic layer is formed on the light emitting layer 32 (step S6 in FIG. 1), and an electron injection layer 34 as an organic layer is formed on the electron transport layer 33 (step S7 in FIG. 1).

In the present exemplary embodiment, the hole injection layer 30, the hole transport layer 31 and the light emitting layer 32 are formed, respectively, in a substrate processing system 100 to be described later. That is, an organic material is subjected to a coating processing, a vacuum-drying processing, and a firing processing sequentially by an inkjet method to form the hole injection layer 30, the hole transport layer 31 and the light emitting layer 32.

Each of the electron transport layer 33 and the electron injection layer 34 is formed by, for example, a deposition method.

The cathode 40 is formed on the electron injection layer 34 (step S8 in FIG. 1). The cathode 40 is formed by, for example, a deposition method. The cathode 40 is made of, for example, aluminum.

In the OLED 1 manufactured as described above, a voltage is applied between the anode 10 and the cathode 40 so that a predetermined number of holes injected by the hole injection layer 30 is transported to the light emitting layer 32 through the hole transport layer 31, and a predetermined number of electrons injected by the electron injection layer 34 is transported to the light emitting layer 32 through the electron transport layer 33. Within the light emitting layer 32, the holes and the electrons are recombined with each other to form excited molecules so that the light emitting layer 32 emits light.

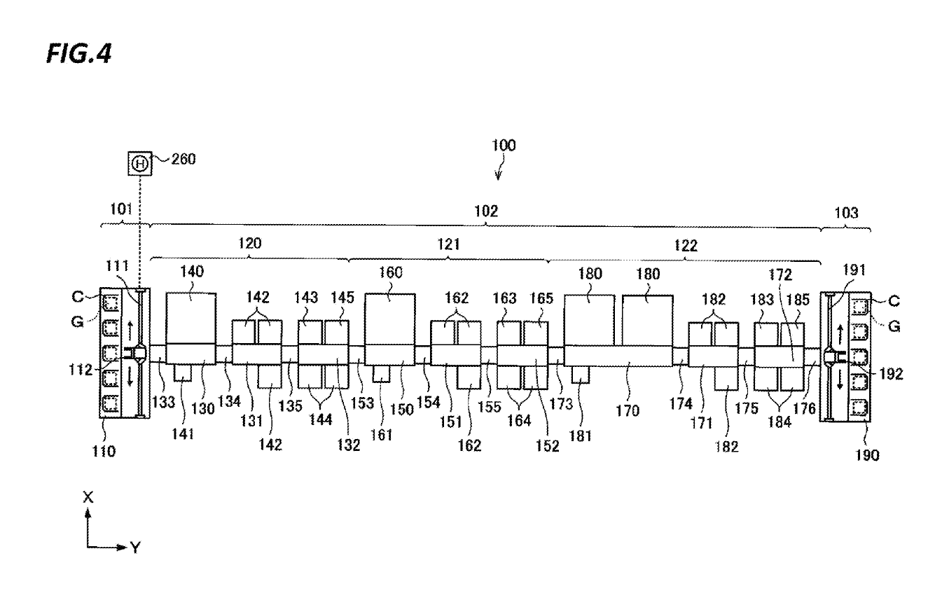

Hereinafter, a substrate processing system 100 including the defect inspecting apparatus according to the present exemplary embodiment will be described. FIG. 4 is an explanatory view schematically illustrating the configuration of the substrate processing system 100. An anode 10 and a partition wall 20 have been formed in advance on a glass substrate G to be processed by the substrate processing system 100, and a hole injection layer 30, a hole transport layer 31 and a light emitting layer 32 are formed in the substrate processing system 100.

The substrate processing system 100 has a configuration in which a carrying-in station 101, a processing station 102, and a carrying-out station 103 are integrally connected. The carrying-in station 101 is configured to carry a plurality of glass substrates G of a cassette unit into the substrate processing system 100 from the outside, and take out the glass substrates G before processed from a cassette C. The processing station 102 is provided with a plurality of processing apparatuses configured to perform predetermined processings on the glass substrates G. The carrying-out station 103 is configured to load the processed glass substrates G into a cassette C, and carry out the plurality of glass substrates G of a cassette unit from the substrate processing system 100 to the outside. The carrying-in station 101, the processing station 102, and the carrying-out station 103 are disposed in this order to be arranged in the Y direction.

A cassette mounting unit 110 is provided in the carrying-in station 101. On the cassette mounting unit 110, a plurality of cassettes C can be mounted in line in the X direction. That is, the carrying-in station 101 is configured to accommodate the plurality of glass substrates G.

A substrate carrier 112 movable on a conveyance path 111 extending in the X direction is provided in the carrying-in station 101. The substrate carrier 112 is movable in the vertical direction or around the vertical direction, and configured to convey the glass substrates G between the cassettes C and the processing station 102. For example, the substrate carrier 112 conveys the glass substrates G while holding the glass substrates G through suction.

In the processing station 102, a hole injection layer forming section 120 configured to form a hole injection layer 30, a hole transport layer forming section 121 configured to form a hole transport layer 31, and a light emitting layer forming section 122 configured to form a light emitting layer 32 are disposed in this order from the carrying-in station 101 side to be arranged in the Y direction.

A first substrate conveyance region 130, a second substrate conveyance region 131, and a third substrate conveyance region 132 are disposed in this order from the carrying-in station 101 side to be arranged in the Y direction in the hole injection layer forming section 120. Each of the substrate conveyance regions 130, 131, and 132 is provided to extend in the Y direction, and is provided with a substrate conveyance device (not illustrated) configured to convey the glass substrates G. The substrate conveyance device is movable in the horizontal direction, in the vertical direction and around the vertical direction, and configured to convey the glass substrates G to respective devices provided close to the substrate conveyance regions 130, 131, and 132.

A transition device 133 configured to deliver the glass substrates G is provided between the carrying-in station 101 and the first substrate conveyance region 130. Likewise, transition devices 134 and 135 are provided between the first substrate conveyance region 130 and the second substrate conveyance region 131, and between the second substrate conveyance region 131 and the third substrate conveyance region 132, respectively.

A coating apparatus 140 configured to coat an organic material for forming the hole injection layer 30 on the glass substrate G (anode 10) is provided at the positive X direction side of the first substrate conveyance region 130. In the coating apparatus 140, an organic material is coated to a predetermined position on the glass substrate G, that is, an inside of openings 21 of the partition wall 20 by an inkjet method. The organic material in the present exemplary embodiment is a solution including a predetermined material for forming the hole injection layer 30 which is dissolved in an organic solvent.

A buffer device 141 configured to temporarily accommodate the plurality of glass substrates G is provided at the negative x direction side of the first substrate conveyance region 130.

A plurality of vacuum-drying apparatuses 142 (e.g., five vacuum-drying apparatuses) configured to vacuum-dry the organic material coated by the coating apparatus 140 is provided to be stacked at the positive X direction side and at the negative X direction side of the second substrate conveyance region 131. The vacuum-drying apparatus 142 includes, for example, a turbo molecular pump (not illustrated), and is configured such that the internal atmosphere is reduced to, for example, 1 Pa or less to dry the organic material.

A plurality of heat processing apparatuses 143 configured to heat-process and fire the organic material dried by the vacuum-drying apparatus 142 is provided to be stacked in a plurality of stages (e.g., 20 stages) at the positive X direction side of the third substrate conveyance region 132. Within the heat processing apparatus 143, a heating plate (not illustrated) is provided on which the glass substrate G is mounted. The organic material is fired by the heating plate.

A plurality of temperature controlling devices 144 configured to control a temperature of the glass substrate G heat-processed by the heat processing apparatus 143 to a predetermined temperature, for example, room temperature, is provided at the negative X direction side of the third substrate conveyance region 132.

A defect inspecting apparatus 145 configured to inspect a defect on the hole injection layer 30 formed on the glass substrate G is provided at the positive X direction side of the third substrate conveyance region 132.

In the hole injection layer forming section 120, the number or disposition of the coating apparatus 140, the buffer device 141, the vacuum-drying apparatuses 142, the heat processing apparatuses 143, the temperature controlling devices 144, and the defect inspecting apparatus 145 may be arbitrarily selected.

A first substrate conveyance region 150, a second substrate conveyance region 151, and a third substrate conveyance region 152 are disposed in this order from the hole injection layer forming section 120 side to be arranged in the Y direction in the hole transport layer forming section 121. Each of the substrate conveyance regions 150, 151, and 152 is provided to extend in the Y direction, and is provided with a substrate conveyance device (not illustrated) configured to convey the glass substrates G. The substrate conveyance device is movable in the horizontal direction, in the vertical direction and around the vertical direction, and configured to convey the glass substrates G to respective devices provided close to the substrate conveyance regions 150, 151, and 152.

In the third substrate conveyance region 152, heat processing apparatuses 163, temperature controlling devices 164, and a defect inspecting apparatus 165 to be described later are provided close to each other, and the insides of these respective devices 163 to 165 are maintained in a low oxygen and low dew point atmosphere. Accordingly, the inside of the third substrate conveyance region 152 is also is maintained in a low oxygen and low dew point atmosphere. In the following description, a low oxygen atmosphere indicates an atmosphere at an oxygen concentration lower than that of air, for example, an atmosphere at an oxygen concentration of 10 ppm or less, and a low dew point atmosphere indicates an atmosphere at a dew point temperature lower than that of air, for example, an atmosphere at a dew point temperature of −10° C. or less. As such a low oxygen and low dew point atmosphere, an inert gas such as, for example, a nitrogen gas is used.

Transition devices 153 and 154 configured to deliver the glass substrates G are provided between the hole injection layer forming section 120 and the first substrate conveyance region 150, and between the first substrate conveyance region 150 and the second substrate conveyance region 151, respectively. A load lock device 155 configured to temporarily accommodate the glass substrates G is provided between the second substrate conveyance region 151 and the third substrate conveyance region 152. The load lock device 155 is configured to switch the internal atmosphere between an air atmosphere and a low oxygen and low dew point atmosphere.

A coating apparatus 160 configured to coat an organic material for forming the hole transport layer 31 on the glass substrate G (hole injection layer 30) is provided at the positive X direction side of the first substrate conveyance region 150. In the coating apparatus 160, an organic material is coated to a predetermined position on the glass substrate G, that is, an inside of the openings 21 of the partition wall 20 by an inkjet method. The organic material in the present exemplary embodiment is a solution including a predetermined material for forming the hole transport layer 31 which is dissolved in an organic solvent.

A buffer device 161 configured to temporarily accommodate the plurality of glass substrates G is provided at the negative X direction side of the first substrate conveyance region 150.

A plurality of vacuum-drying apparatuses 162 (e.g., five vacuum-drying apparatuses) configured to vacuum-dry the organic material coated by the coating apparatus 160 is provided to be stacked at the positive X direction side and at the negative X direction side of the second substrate conveyance region 151. The vacuum-drying apparatus 162 includes, for example, a turbo molecular pump (not illustrated), and is configured such that the internal atmosphere is reduced to, for example, 1 Pa or less to dry the organic material.

A plurality of heat processing apparatuses 163 configured to heat-process and fire the organic material dried by the vacuum-drying apparatus 162 is provided to be stacked in a plurality of stages (e.g., 20 stages) at the positive X direction side of the third substrate conveyance region 152. Within the heat processing apparatus 163, a heating plate (not illustrated) is provided on which the glass substrate G is mounted. The organic material is fired by the heating plate. The inside of the heat processing apparatus 163 is maintained in a low oxygen and low dew point atmosphere.

A plurality of temperature controlling devices 164 configured to control a temperature of the glass substrate G heat-processed by the heat processing apparatus 163 to a predetermined temperature, for example, room temperature, is provided at the negative X direction side of the third substrate conveyance region 152. The inside of the temperature controlling device 164 is maintained in a low oxygen and low dew point atmosphere.

A defect inspecting apparatus 165 configured to inspect a defect on the hole transport layer 31 formed on the glass substrate G is provided at the positive X direction side of the third substrate conveyance region 152. The inside of the defect inspecting apparatus 165 is maintained in a low oxygen and low dew point atmosphere.

In the hole transport layer forming section 121, the number or disposition of the coating apparatus 160, the buffer device 161, the vacuum-drying apparatuses 162, the heat processing apparatuses 163, the temperature controlling devices 164, and the defect inspecting apparatus 165 may be arbitrarily selected.

A first substrate conveyance region 170, a second substrate conveyance region 171 and a third substrate conveyance region 172 are disposed in this order from the hole transport layer forming section 121 side to be arranged in the Y direction in the light emitting layer forming section 122. Each of the substrate conveyance regions 170, 171, and 172 is provided to extend in the Y direction, and is provided with a substrate conveyance device (not illustrated) configured to convey the glass substrates G. The substrate conveyance device is movable in the horizontal direction, in the vertical direction and around the vertical direction, and configured to convey the glass substrates G to respective devices provided close to the substrate conveyance regions 170, 171, and 172.

In the third substrate conveyance region 172, heat processing apparatuses 183, temperature controlling devices 184, and a defect inspecting apparatus 185 to be described later are provided close to each other, and insides of these respective devices 183 to 185 are maintained in a low oxygen and low dew point atmosphere. Accordingly, the inside of the third substrate conveyance region 172 is also maintained in a low oxygen and low dew point atmosphere.

Transition devices 173, and 174 configured to deliver the glass substrates G are provided between the hole transport layer forming section 121 and the first substrate conveyance region 170, and between the first substrate conveyance region 170 and the second substrate conveyance region 171, respectively. Load lock devices 175 and 176 configured to temporarily accommodate the glass substrates G are provided between the second substrate conveyance region 171 and the third substrate conveyance region 172, and between the third substrate conveyance region 172 and the carrying-out station 103, respectively. The load lock devices 175 and 176 are configured to switch the internal atmosphere between an air atmosphere and a low oxygen and low dew point atmosphere.

For example, two coating apparatuses 180 configured to coat an organic material for forming the light emitting layer 32 on the glass substrate G (hole transport layer 31) are provided at the positive X direction side of the first substrate conveyance region 170. In the coating apparatus 180, an organic material is coated to a predetermined position on the glass substrate G, that is, an inside of the openings 21 of the partition wall 20 by an inkjet method. The organic material in the present exemplary embodiment is a solution including a predetermined material for forming the light emitting layer 32 which is dissolved in an organic solvent.

A buffer device 181 configured to temporarily accommodate the plurality of glass substrates G is provided at the negative X direction side of the first substrate conveyance region 170.

A plurality of vacuum-drying apparatuses 182 (e.g., five vacuum-drying apparatuses) configured to vacuum-dry the organic material coated by the coating apparatus 180 is provided to be stacked at the positive X direction side and at the negative X direction side of the second substrate conveyance region 171. The vacuum-drying apparatus 182 includes, for example, a turbo molecular pump (not illustrated), and is configured such that the internal atmosphere is reduced to, for example, 1 Pa or less to dry the organic material.

A plurality of heat processing apparatuses 183 configured to heat-process and fire the organic material dried by the vacuum-drying apparatus 182 is provided to be stacked in a plurality of stages (e.g., 20 stages) at the positive X direction side of the third substrate conveyance region 172. Within the heat processing apparatus 183, a heating plate (not illustrated) is provided on which the glass substrate G is mounted. The organic material is fired by the heating plate. The inside of the heat processing apparatus 183 is maintained in a low oxygen and low dew point atmosphere.

A plurality of temperature controlling devices 184 configured to control a temperature of the glass substrate G heat-processed by the heat processing apparatus 183 to a predetermined temperature, for example, room temperature, is provided at the negative X direction side of the third substrate conveyance region 172. The inside of the temperature controlling device 184 is maintained in a low oxygen and low dew point atmosphere.

A defect inspecting apparatus 185 configured to inspect a defect on the light emitting layer 32 formed on the glass substrate G is provided at the positive X direction side of the third substrate conveyance region 172. The inside of the defect inspecting apparatus 185 is maintained in a low oxygen and low dew point atmosphere.

In the light emitting layer forming section 122, the number or disposition of the coating apparatuses 180, the buffer device 181, the vacuum-drying apparatuses 182, the heat processing apparatuses 183, the temperature controlling devices 184, and the defect inspecting apparatus 185 may be arbitrarily selected.

A cassette mounting unit 190 is provided in the carrying-out station 103. On the cassette mounting unit 190, a plurality of cassettes C can be mounted in line in the X direction. That is, the carrying-out station 103 is configured to accommodate the plurality of glass substrates G.

A substrate carrier 192 movable on a conveyance path 191 extending in the X direction is provided in the carrying-out station 103. The substrate carrier 192 is movable in the vertical direction or around the vertical direction, and configured to convey the glass substrates G between the cassettes C and the processing station 102. For example, the substrate carrier 192 conveys the glass substrates G while holding the glass substrates G through suction.

It is desirable that the inside of the carrying-out station 103 is maintained in a low oxygen and low dew point atmosphere.

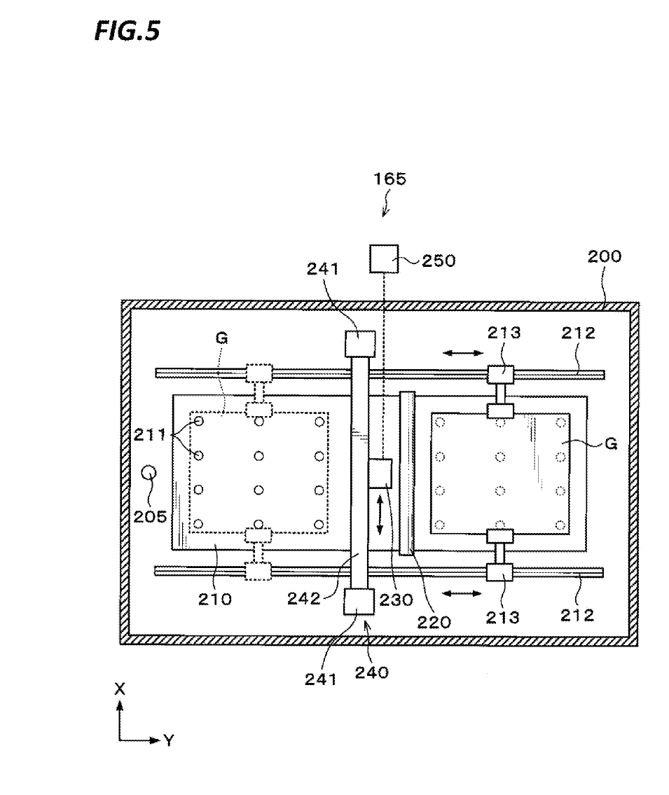

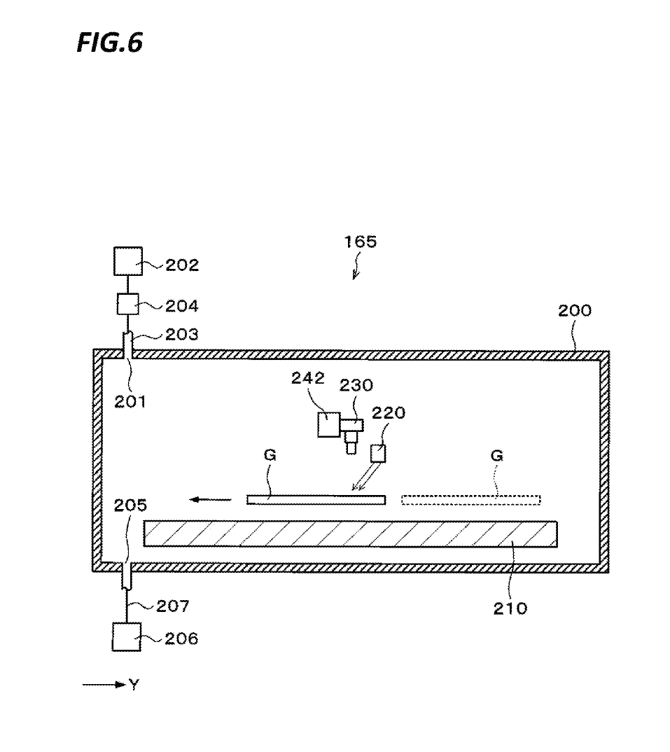

Hereinafter, the configuration of the above described defect inspecting apparatuses 145, 165, and 185 will be described. The defect inspecting apparatus 165, as illustrated in FIGS. 5 and 6, includes a processing container 200 of which inside is sealable. A carrying-in/out port (not illustrated) for glass substrates G is formed in the side surface of the processing container 200 at the third substrate conveyance region 152 side, and an opening/closing shutter (not illustrated) is provided in the carrying-in/out port.

A gas supply port 201 configured to supply a low dew point inert gas such as, for example, a nitrogen gas, into the processing container 200 is formed in the ceiling surface of the processing container 200. A gas supply tube 203 communicating with a gas supply source 202 is connected to the gas supply port 201. A supply device group 204 including, for example, a valve or a flow control unit which is configured to control the flow of an inert gas, is provided in the gas supply tube 203.

An exhaust port 205 configured to exhaust the internal atmosphere of the processing container 200 is formed in the bottom surface of the processing container 200. An intake pipe 207 communicating with a negative pressure generating device 206 such as, for example, a vacuum pump is connected to the exhaust port 205.

As described above, the low dew point inert gas is supplied from the gas supply port 201 into the processing container 200, and the internal atmosphere of the processing container 200 is exhausted from the exhaust port 205 to maintain the inside of the processing container 200 at a low oxygen and low dew point atmosphere.

A floating stage 210 extending in the Y direction is provided within the processing container 200. A plurality of gas ejecting holes 211 is formed in the top surface of the floating stage 210. By ejecting a gas from the gas ejecting holes 211, the glass substrate G may be floated above the entire surface of the floating stage 210. The floating stage 210 is configured to convey the glass substrate G in the Y direction.

A pair of guide rails 212 extending in the Y direction are formed at both sides of the floating stage 210 in the width direction (X direction). Holding arms 213 which move while holding the width direction end portions of the glass substrate G are provided in the guide rails 212, respectively. The both end portions of the glass substrate G floated above the floating stage 210 are held by the holding arms 213 so that the glass substrate G is moved along the guide rails 212 in the Y direction.

An illumination unit 220 configured to irradiate a near infrared light toward a hole transport layer 31 on the glass substrate G, and an imaging unit 230 configured to image the hole transport layer 31 irradiated with the near infrared light from the illumination unit 220 are provided around the center within the processing container 200, above the floating stage 210. The illumination unit 220 and the imaging unit 230 are disposed to be arranged in the longitudinal direction (Y direction) of the floating stage 210.

The illumination unit 220 extends in the width direction (X direction) of the floating stage 210, and the extension length of the illumination unit 220 is longer than the width of the glass substrate G held by the holding arms 213. The illumination unit 220 is disposed so as to irradiate a near infrared light to the hole transport layer 31 in at least a range to be imaged by the imaging unit 230. The illumination unit 220 includes a light source (not illustrated) for the near infrared light, and the near infrared light irradiated from the illumination unit 220 has a wavelength ranging from 0.7 μm to 2.5 μm, more preferably 0.8 μm to 1.0 μm.

The imaging unit 230 is supported by a supporting unit 240 provided to straddle the floating stage 210 in the width direction (X direction). The supporting unit 240 includes a pair of vertical members 241 which are provided at both outsides of the floating stage 210 to extend in the vertical direction, and a horizontal member 242 which is bridged between the pair of vertical members 241 to extend in the width direction of the floating stage 210 above the floating stage 210. The imaging unit 230 is supported by the horizontal member 242, and is configured to be movable in the X direction along the horizontal member 242 by a driving unit (not illustrated) such as, for example, a motor.

As for the imaging unit 230, for example, a line sensor camera is used. An image imaged by the imaging unit 230 is output to an inspecting unit 250. In the inspecting unit 250, a defect on the hole transport layer 31 is inspected based on the output image, for example, the gradation of the image.

In the present exemplary embodiment, one imaging unit 230 is provided, but a plurality of imaging units may be provided.

The configuration of the defect inspecting apparatus 185 is the same as the above described configuration of the defect inspecting apparatus 165, and thus descriptions thereof will be omitted. Also, the defect inspecting apparatus 145 has almost the same configuration as the above described configuration of the defect inspecting apparatus 165. However, the inside of the defect inspecting apparatus 145 does not have to be maintained in a low oxygen and low dew point atmosphere. Thus, in the defect inspecting apparatus 145, some elements of the defect inspecting apparatus 165, such as the gas supply port 201, the gas supply source 202, the gas supply tube 203, the supply device group 204, the exhaust port 205, the negative pressure generating device 206, and the intake pipe 207 may be omitted.

In the above described substrate processing system 100, as illustrated in FIG. 4, a control unit 260 is provided. The control unit 260 is, for example, a computer, and includes a program storage unit (not illustrated). The program storage unit stores a program for controlling processings on glass substrates G in the substrate processing system 100. The program may be recorded in a computer-readable storage medium H such as, for example, a computer readable hard disk (HD), a flexible disk (FD), a compact disk (CD), a magneto optical disk (MO), and a memory card, and may be installed to the control unit 260 from the storage medium H.

Hereinafter, descriptions will be made on a method of processing glass substrates G by using the substrate processing system 100 configured as described above.

First, a cassette C which accommodates a plurality of glass substrates G is carried into a carrying-in station 101 and mounted on a cassette mounting unit 110. Glass substrates G are sequentially taken out from the cassette C on the cassette mounting unit 110 by a substrate carrier 112. In the present exemplary embodiment, in the substrate processing system 100, a tact time for a glass substrate G is 90 sec.

The glass substrate G taken out from the cassette C is conveyed to a transition device 133 of a hole injection layer forming section 120 by the substrate carrier 112, and is conveyed to a coating apparatus 140 through a first substrate conveyance region 130. In the coating apparatus 140, an organic material for a hole injection layer 30 is coated to a predetermined position on the glass substrate G (anode 10), that is, an inside of openings 21 of a partition wall 20 by an inkjet method. In the coating apparatus 140, a time required for a coating processing is, for example, 90 sec.

The glass substrate G is conveyed to a transition device 134 through the first substrate conveyance region 130, and is conveyed to a vacuum-drying apparatus 142 through a second substrate conveyance region 131. In the vacuum-drying apparatus 142, the internal atmosphere is reduced, and the organic material coated on the glass substrate G is dried. In the vacuum-drying apparatus 142, a time required for a vacuum-drying processing is, for example, 7 min.

The glass substrate G is conveyed to a transition device 135 through the second substrate conveyance region 131, and is conveyed to a heat processing apparatus 143 through a third substrate conveyance region 132. In the heat processing apparatus 143, the glass substrate G mounted on a heating plate is heated at a predetermined temperature, for example, 180° C., to fire the organic material of the glass substrate G. In the heat processing apparatus 143, a time required for a heat processing is, for example, 30 min.

The glass substrate G is conveyed to a temperature controlling device 144 through the third substrate conveyance region 132. In the temperature controlling device 144, the temperature of the glass substrate G is controlled to a predetermined temperature, for example, room temperature. In this manner, the hole injection layer 30 is formed on the glass substrate G (anode 10).

The glass substrate G is conveyed to a defect inspecting apparatus 145 through the third substrate conveyance region 132. Here, the inside of a processing container 200 of the defect inspecting apparatus 145 is opened to air atmosphere. The inside of the processing container 200 is maintained in the dark without light.

The glass substrate G carried into the defect inspecting apparatus 145 is held by holding arms 213. The glass substrate G is floated by a gas ejected from gas ejecting holes of a floating stage 210, while moving along the longitudinal direction (Y direction) of the floating stage 210 toward an illumination unit 220 and an imaging unit 230 at a predetermined speed. When the glass substrate G passes below the imaging unit 230, a near infrared light is irradiated toward the hole injection layer 30 of the glass substrate G obliquely downward from the illumination unit 220. Through intensive studies, the inventors found that even if a near infrared light of a wavelength ranging from 0.7 μm to 2.5 μm is irradiated to the hole injection layer 30, the hole injection layer 30 is not deteriorated because the near infrared light has a low energy. Also, it was found that even if the near infrared light of a long wavelength is used, a defect on the hole injection layer 30 is sufficiently distinguishable by an image imaged by the imaging unit 230. By the imaging unit 230, the hole injection layer 30 of the glass substrate G below the imaging unit 230 is imaged. The imaged image of the hole injection layer 30 is output to an inspecting unit 250, and a defect on the hole injection layer 30 is inspected by the inspecting unit 250 based on the output image.

In the defect inspecting apparatus 145, the imaging unit 230 may not image the whole of the glass substrate G in the width direction (X direction) at once. In this case, while the glass substrate G is reciprocated in the longitudinal direction (Y direction) of the floating stage 210, the imaging unit 230 is moved in the width direction (X direction) of the floating stage 210 to image the whole of the hole injection layer 30 of the glass substrate G.

In the defect inspecting apparatus 145, when it is determined that a defect is present in the hole injection layer 30, the glass substrate G is carried out to the outside of the substrate processing system 100.

In the defect inspecting apparatus 145, when it is determined that no defect is present in the hole injection layer 30, the glass substrate G is conveyed to a transition device 153 of a hole transport layer forming section 121 through the third substrate conveyance region 132, and conveyed to a coating apparatus 160 through a first substrate conveyance region 150. In the coating apparatus 160, an organic material for a hole transport layer 31 is coated on the glass substrate G (hole injection layer 30), by an inkjet method. In the coating apparatus 160, a time required for a coating processing is, for example, 90 sec.

The glass substrate G is conveyed to a transition device 154 through the first substrate conveyance region 150, and is conveyed to a vacuum-drying apparatus 162 through a second substrate conveyance region 151. In the vacuum-drying apparatus 162, the internal atmosphere is reduced, and the organic material coated on the glass substrate G is dried. In the vacuum-drying apparatus 162, a time required for a vacuum-drying processing is, for example, 7 min.

The glass substrate G is conveyed to a load lock device 155 through the second substrate conveyance region 151. When the glass substrate G is carried into the load lock device 155, the inside is switched to a low oxygen and low dew point atmosphere. The inside of the load lock device 155 is communicated with the inside of a third substrate conveyance region 152 which is maintained in a low oxygen and low dew point atmosphere in the same manner as the load lock device 155.

The glass substrate G is conveyed to a heat processing apparatus 163 through the third substrate conveyance region 152. The inside of the heat processing apparatus 163 is also maintained in a low oxygen and low dew point atmosphere. In the heat processing apparatus 163, the glass substrate G mounted on a heating plate is heated at a predetermined temperature, for example, 200° C., to fire the organic material of the glass substrate G. In the heat processing apparatus 163, a time required for a heat processing is, for example, 30 min.

The glass substrate G is conveyed to a temperature controlling device 164 through the third substrate conveyance region 152. The inside of the temperature controlling device 164 is also maintained in a low oxygen and low dew point atmosphere. In the temperature controlling device 164, the temperature of the glass substrate G is controlled to a predetermined temperature, for example, room temperature. In this manner, the hole transport layer 31 is formed on the glass substrate G (hole injection layer 30).

The glass substrate G is conveyed to a defect inspecting apparatus 165 through the third substrate conveyance region 152. The inside of the defect inspecting apparatus 165 is maintained in a low oxygen and low dew point atmosphere. In the defect inspecting apparatus 165, a defect on the hole transport layer 31 is inspected. The defect inspection of the hole transport layer 31 is the same as the above described defect inspection of the hole injection layer 30 in the defect inspecting apparatus 145, and thus descriptions thereof will be omitted.

In the defect inspecting apparatus 165, when it is determined that a defect is present in the hole transport layer 31, the glass substrate G is carried out to the outside of the substrate processing system 100.

In the defect inspecting apparatus 165, when it is determined that no defect is present in the hole transport layer 31, the glass substrate G is conveyed to a transition device 173 of a light emitting layer forming section 122 through the third substrate conveyance region 152, and conveyed to a coating apparatus 180 through a first substrate conveyance region 170. In the coating apparatus 180, an organic material for a light emitting layer 32 is coated on the glass substrate G (hole transport layer 31), by an inkjet method. In the coating apparatus 180, a time required for a coating processing is, for example, 2 min.

The glass substrate G is conveyed to a transition device 174 through the first substrate conveyance region 170, and is conveyed to a vacuum-drying apparatus 182 through a second substrate conveyance region 171. In the vacuum-drying apparatus 182, the internal atmosphere is reduced, and the organic material coated on the glass substrate G is dried. In the vacuum-drying apparatus 182, a time required for a vacuum-drying processing is, for example, 7 min.

The glass substrate G is conveyed to a load lock device 175 through the second substrate conveyance region 171. When the glass substrate G is carried into the load lock device 175, the inside is switched to a low oxygen and low dew point atmosphere. The inside of the load lock device 175 is communicated with the inside of a third substrate conveyance region 172 which is maintained in a low oxygen and low dew point atmosphere in the same manner as the load lock device 175.

The glass substrate G is conveyed to a heat processing apparatus 183 through the third substrate conveyance region 172. The inside of the heat processing apparatus 183 is also maintained in a low oxygen and low dew point atmosphere. In the heat processing apparatus 183, the glass substrate G mounted on a heating plate is heated at a predetermined temperature, for example, 160° C., to fire the organic material of the glass substrate G. In the heat processing apparatus 183, a time required for a heat processing is, for example, 10 min.

The glass substrate G is conveyed to a temperature controlling device 184 through the third substrate conveyance region 172. The inside of the temperature controlling device 184 is also maintained in a low oxygen and low dew point atmosphere. In the temperature controlling device 184, the temperature of the glass substrate G is controlled to a predetermined temperature, for example, room temperature. In this manner, the light emitting layer 32 is formed on the glass substrate G (hole transport layer 31).

The glass substrate G is conveyed to a defect inspecting apparatus 185 through the third substrate conveyance region 172. The inside of the defect inspecting apparatus 185 is maintained in a low oxygen and low dew point atmosphere. In the defect inspecting apparatus 185, a defect on the light emitting layer 32 is inspected. The defect inspection of the light emitting layer 32 is the same as the above described defect inspection of the hole injection layer 30 in the defect inspecting apparatus 145, and thus descriptions thereof will be omitted.

In the defect inspecting apparatus 185, when it is determined that a defect is present in the light emitting layer 32, the glass substrate G is carried out to the outside of the substrate processing system 100.

In the defect inspecting apparatus 185, when it is determined that no defect is present in the light emitting layer 32, the glass substrate G is conveyed to a load lock device 176 through the third substrate conveyance region 172. The inside of the load lock device 176 is maintained in a low oxygen and low dew point atmosphere. The inside of the load lock device 176 is communicated with the inside of a carrying-out station 103 which is maintained in a low oxygen and low dew point atmosphere in the same manner as the load lock device 176.

The glass substrate G is conveyed to a predetermined cassette C on a cassette mounting unit 190 by a substrate carrier 192 of the carrying-out station 103. In this manner, a series of processings on the glass substrates G is completed in the substrate processing system 100.

In the above described embodiment, the illumination unit 220 irradiates a near infrared light toward the respective organic layers 30 to 32 (the hole injection layer 30, the hole transport layer 31 and the light emitting layer 32) on the glass substrate G, and the imaging unit 230 images the organic layers 30 to 32 irradiated with the near infrared light so as to inspect the defects of the respective organic layers 30 to 32. Here, the energy of the near infrared light with a wavelength ranging from 0.7 μm to 2.5 μm is lower than the energy of a visible light. Thus, the respective organic layers 30 to 32 are not deteriorated by the near infrared light. Even if such a near infrared light of a long wavelength is used, defects of the respective organic layers 30 to 32 are sufficiently distinguishable by images imaged by the imaging unit 230. Accordingly, it is possible to appropriately inspect defects of the respective organic layers 30 to 32 on the glass substrate G.

Here, in the substrate processing system 100 according to the present exemplary embodiment, since a tact time for the glass substrate G is 90 sec, about 100 sheets of glass substrates G are carried into the substrate processing system 100 and subjected to predetermined processings at the time of operation. Even if a defect is present in any one of the organic layers 30 to 32 on the glass substrate G, the defect may not be found when defect inspection is not performed for each of the organic layers 30 to 32 as in the present exemplary embodiment, causing a failure in all of the glass substrates G within the substrate processing system 100. In this case, the yield of a product may be lowered.

In relation to this feature, according to the present exemplary embodiment, each time each of the organic layers 30 to 32 is formed on the glass substrate G, a defect on each of the organic layers 30 to 32 is inspected. Thus, only a defective glass substrate G may be carried out from the substrate processing system 100. Then, the defective glass substrate G does not need to be subjected to the following processings, and thus unnecessary processings may be omitted. Other glass substrates G may be subjected to appropriate processings. Accordingly, the yield of the OLED 1 as a product may be improved, thereby improving the manufacturing efficiency of the OLED 1.

The inside of the defect inspecting apparatus 165 and 185 is maintained in a low oxygen and low dew point atmosphere. Thus, the hole transport layer 31 and the light emitting layer 32 to be inspected by the defect inspecting apparatus 165 and 185, respectively, may be suppressed from being oxidized or adhered with moisture. Accordingly, the hole transport layer 31 and the light emitting layer 32 may be appropriately formed on the glass substrate G.

In the present exemplary embodiment, the inside of the defect inspecting apparatus 145 is set to air atmosphere, but may be maintained in a low oxygen and low dew point atmosphere.

In the above described exemplary embodiment, the defect inspecting apparatuses 145, 165 and 185 inspect the respective organic layers 30 to 32 after the heat processing in the heat processing apparatuses 143, 163 and 183, respectively, but may inspect the respective organic layers 30 to 32 after the vacuum-drying in the vacuum-drying apparatuses 142, 162 and 182. After the vacuum-drying in the vacuum-drying apparatuses 142, 162 and 182, organic solvents within the respective organic layers 30 to 32 are almost evaporated so that the respective organic layers 30 to 32 are dried. Thus, in the defect inspecting apparatuses 145, 165 and 185, defects of the vacuum-dried organic layers 30 to 32 may be appropriately inspected.

The layout of the substrate processing system 100 according to the above described exemplary embodiment is not limited to a layout illustrated in FIG. 4.

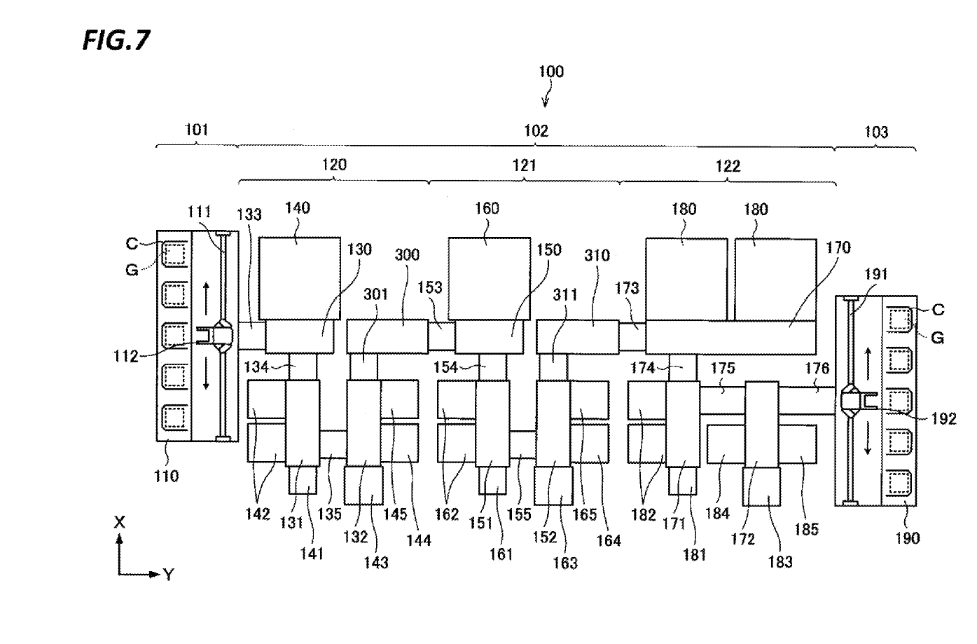

For example, in the hole injection layer forming section 120 of the processing station 102, the respective substrate conveyance regions 130, 131 and 132 are disposed to be arranged linearly in the Y direction, but may be disposed in a curved manner in a plan view as illustrated in FIG. 7. In this case, in addition to the substrate conveyance regions 130, 131 and 132, a fourth substrate conveyance region 300 is disposed between the third substrate conveyance region 132 and the transition device 153 of the hole transport layer forming section 121. A transition device 301 is further provided between the third substrate conveyance region 132 and the fourth substrate conveyance region 300. The first substrate conveyance region 130 and the fourth substrate conveyance region 300 extend in the Y direction, respectively and are disposed to be arranged in the Y direction. The second substrate conveyance region 131 and the third substrate conveyance region 132 extend in the X direction, respectively and are disposed in parallel.

Likewise, in the hole transport layer forming section 121, the respective substrate conveyance regions 150, 151 and 152 are disposed in a curved manner. In this case, a fourth substrate conveyance region 310 and a transition device 311 are additionally disposed between the third substrate conveyance region 152 and the transition device 173 of the light emitting layer forming section 122, respectively. The first substrate conveyance region 150 and the fourth substrate conveyance region 310 extend in the Y direction, respectively and are disposed to be arranged in the Y direction. The second substrate conveyance region 151 and the third substrate conveyance region 152 extend in the X direction, respectively and are disposed in parallel.

Likewise, in the light emitting layer forming section 122, the respective substrate conveyance regions 170, 171 and 172 are disposed in a curved manner. The first substrate conveyance region 170 is disposed to extend in the Y direction. The second substrate conveyance region 171 and the third substrate conveyance region 172 are disposed in parallel to extend in the X direction, respectively.

In the present exemplary embodiment, the same effect in the above described exemplary embodiment may be achieved. That is, the respective organic layers 30 to 32 formed on the glass substrate G may be appropriately inspected, thereby improving the yield and the manufacturing efficiency of the OLED 1.

In the above described exemplary embodiments, defects of the hole injection layer 30, the hole transport layer 31 and the light emitting layer 32 formed in the substrate processing system 100 are inspected. However, the present disclosure may be employed in inspecting defects of the electron transport layer 33 and the electron injection layer 34 formed at the outside of the substrate processing system 100. In this case, a defect inspecting apparatus having the same configuration as the above described configuration of the defect inspecting apparatuses 145, 165 and 185 may be used to appropriately inspect the defects of the electron transport layer 33 and the electron injection layer 34. Here, it is preferable that the inside of the defect inspecting apparatus is maintained at almost the same vacuum degree as in formation of the electron transport layer 33 and the electron injection layer 34 by a deposition method.

In the above described exemplary embodiments, the electron transport layer 33 and the electron injection layer 34 are formed on the glass substrate G by a deposition method at the outside of the substrate processing system 100, but may be formed on the glass substrate G in the substrate processing system 100 like the hole injection layer 30, the hole transport layer 31 and the light emitting layer 32. That is, according to the organic material used for each of the electron transport layer 33 and the electron injection layer 34, the electron transport layer 33 and the electron injection layer 34 may be formed on the glass substrate G through a coating processing of the organic material by an inkjet method, a vacuum-drying processing of the organic material, and a firing processing of the organic material.

In this case, in the processing station 102 of the substrate processing system 100, an electron transport layer forming section and an electron injection layer forming section having the same configuration as those of the respective layer forming sections 120 to 122 are disposed, respectively. In the substrate processing system 100, defect inspections on the electron transport layer 33 and the electron injection layer 34 are performed so that the electron transport layer 33 and the electron injection layer 34 may be appropriately formed.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for inspecting a defect comprising:
an illumination unit configured to irradiate a near infrared light toward at least one of organic layers stacked on a substrate in an organic light emitting diode; and
an imaging unit configured to image the at least one of the organic layers irradiated with the near infrared light illuminated from the illumination unit, thereby inspecting the defect on the at least one of the organic layers.

2. The apparatus of claim 1, wherein a wavelength of the near infrared light ranges from 0.7 μm to 2.5 μm.

3. The apparatus of claim 1, further comprising:
a processing container configured to accommodate the illumination unit and the imaging unit therein, and perform inspection of the at least one of the organic layers,
wherein an inside of the processing container is maintained in an atmosphere at an oxygen concentration lower than an oxygen concentration of air and at a dew point temperature lower than a dew point temperature of air.

4. The apparatus of claim 3, wherein the at least one of the organic layers is a hole injection layer, a hole transport layer or a light emitting layer.

5. The apparatus of claim 1, wherein when the at least one of the organic layers is formed, a coating processing of an organic material on the substrate, a drying processing of the organic material, and a firing processing of the organic material are sequentially performed in this order, and
inspection of the at least one of the organic layers is performed after the drying processing or the firing processing.

6. A method of inspecting a defect comprising:
irradiating a near infrared light toward at least one of organic layers stacked on a substrate in an organic light emitting diode from an illumination unit; and
imaging the at least one of the organic layers irradiated with the near infrared light illuminated from the illumination unit by an imaging unit, thereby inspecting the defect on the at least one of the organic layers.

7. The method of claim 6, wherein a wavelength of the near infrared light ranges from 0.7 μm to 2.5 μm.

8. The method of claim 6, wherein inspection of the at least one of the organic layers is performed under an atmosphere at an oxygen concentration lower than an oxygen concentration of air, and at a dew point temperature lower than a dew point temperature of air.

9. The method of claim 8, wherein the at least one of the organic layers is a hole injection layer, a hole transport layer or a light emitting layer.

10. The method of claim 6, wherein when the at least one of the organic layers is formed, a coating processing of an organic material on the substrate, a drying processing of the organic material, and a firing processing of the organic material are sequentially performed in this order, and
inspection of the at least one of the organic layers is performed after the drying processing or the firing processing.

11. A non-transitory computer-readable storage medium which stores a program which is operated in a computer of a defect inspecting apparatus to execute the method of claim 6 by the defect inspecting apparatus.
